(19) United States
(12) Patent Application Publication
(10) Pub. No.: US 2026/0048618 A1
(43) Pub. Date: Feb. 19, 2026

(54) TIRE WEAR ESTIMATION

(71) Applicant: Ford Global Technologies, LLC, Dearborn, MI (US)

(72) Inventors: Amirhassan Abbasi, Farmington, MI (US); Rishabh Gupta, Farmington Hills, MI (US); Matthew Aaron Knych, Dearborn, MI (US); Satheesh Kumar Chandran, Livonia, MI (US); Vicky Svidenko, Newcastle, WA (US)

(73) Assignee: Ford Global Technologies, LLC, Dearborn, MI (US)

(21) Appl. No.: 18/804,154

(22) Filed: Aug. 14, 2024

(51) Int. Cl. B60C 11/24

(52) U.S. Cl. CPC B60C 11/246; B60C 11/243

(57) ABSTRACT

For respective instances, noise factors of a vehicle tire are detected. The noise factors include a tire pressure, a load, and a tire speed. For the respective instances, respective radii of the vehicle tire are determined. The respective radii are grouped based on respective discrete sets of noise factors. A transition instance of a health condition for the vehicle tire is estimated based on extrapolating the respective grouped radii.

### BACKGROUND

Vehicles typically include a plurality of wheels with each wheel including a rim and a tire. The tires wear with normal usage and are ultimately replaced when worn. Vehicle maintenance such as wheel alignment, wheel balancing, routine tire rotation, and suspension maintenance can aid in even wear of the tires, which increases the useful life of the tires.

### BRIEF DESCRIPTION OF THE DRAWINGS

FIG. 1 is a block diagram illustrating an example vehicle control system.

FIG. 2 is a block diagram illustrating a side view of an example vehicle tire.

FIG. 3 is an example plot illustrating an unloaded radius of the vehicle tire over time for a given discrete set of noise factors.

FIG. 4 is an example flowchart of an example process for estimating a transition instance of the vehicle tire.

### DETAILED DESCRIPTION

A system includes a computer including a processor and a memory, the memory storing instructions executable by the processor to detect, for respective instances, noise factors of a vehicle tire. The noise factors include a tire pressure, a load, and a tire speed. The instructions further include instructions to determine, for the respective instances, respective radii of the vehicle tire. The instructions further include instructions to group the respective radii based on respective discrete sets of noise factors. The instructions further include instructions to estimate a transition instance of a health condition for the vehicle tire based on extrapolating the respective grouped radii.

The instructions can further include instructions to determine the respective radii based on respective vehicle speeds and respective angular speeds of the vehicle tire. The instructions can further include instructions to determine the respective radii based further on the detected noise factors.

The instructions can further include instructions to, in response to determining a remaining useful life of the vehicle tire based on the estimated transition instance, actuate a human-machine interface to output a message specifying the remaining useful life.

The respective discrete sets of noise factors can be defined by respective minimum thresholds and respective maximum thresholds for the respective noise factors

The transition instance can be estimated via a probabilistic model.

The transition instance can be estimated via a deterministic model.

The transition instance can indicate a future distance travelled or a future time at which the health condition transitions from healthy to unhealthy. The vehicle tire can be healthy based on wear of the vehicle tire being less than a wear threshold, and the vehicle tire is unhealthy based on the wear being greater than or equal to the wear threshold.

The noise factors can be detected via vehicle sensor data.

A method includes detecting, for respective instances, noise factors of a vehicle tire. The noise factors include a tire pressure, a load, and a tire speed. The method further includes determining, for the respective instances, respective radii of the vehicle tire. The method further includes grouping the respective radii based on respective discrete sets of noise factors. The method further includes estimating a transition instance of a health condition for the vehicle tire based on extrapolating the respective grouped radii.

The method can further include determining the respective radii based on respective vehicle speeds and respective angular speeds of the vehicle tire. The method can further include determining the respective radii based further on the detected noise factors.

The method can further include, in response to determining a remaining useful life of the vehicle tire based on the estimated transition instance, actuating a human-machine interface to output a message specifying the remaining useful life.

The respective discrete sets of noise factors can be defined by respective minimum thresholds and respective maximum thresholds for the respective noise factors

The transition instance can be estimated via a probabilistic model.

The transition instance can be estimated via a deterministic model.

The transition instance can indicate a future distance travelled or a future time at which the health condition transitions from healthy to unhealthy. The vehicle tire can be healthy based on wear of the vehicle tire being less than a wear threshold, and the vehicle tire is unhealthy based on the wear being greater than or equal to the wear threshold.

The noise factors can be detected via vehicle sensor data.

Further disclosed herein is a computing device programmed to execute any of the above method steps. Yet further disclosed herein is a computer program product, including a computer readable medium storing instructions executable by a computer processor, to execute an of the above method steps.

During normal driving of the vehicle, the rubber of the tire wears. An unloaded radius of the tire can be estimated based on an effective rolling radius of the tire. The unloaded radius can then be used to estimate an amount of wear of the tire, which in turn can be used to estimate a remaining useful life of the tire. However, data including noise factors (e.g., that may depend on current driving conditions (e.g., an environment around the vehicle, a load in the vehicle, a speed of the vehicle, etc.)) may affect estimation of the unloaded radius. Data including the noise factors may be continuous data across respective ranges, which can increase a deviation between the estimated remaining useful life and an actual remaining useful life of the vehicle tire.

As described herein, a computer can determine respective radii for respective instances and can group the respective radii based on respective discrete sets of noise factors. The computer can then estimate a transition instance of a health condition for the vehicle tire based on the respective grouped radii. Analyzing the respective radii based on respective discrete sets of noise factors allows the computer to account for the noise factors when estimating the radius of the vehicle tire over time, which can reduce a deviation between the estimated remaining useful life and the actual remaining useful life of the vehicle tire. Respective unloaded radii rut will be used in this disclosure as an exemplary radii for estimating the transition instance of the health condition for the vehicle tire 200. However, it should be understood that other radii (e.g., effective rolling radii rₑ) may also be used for estimating the transition instance of the health condition for the vehicle tire 200.

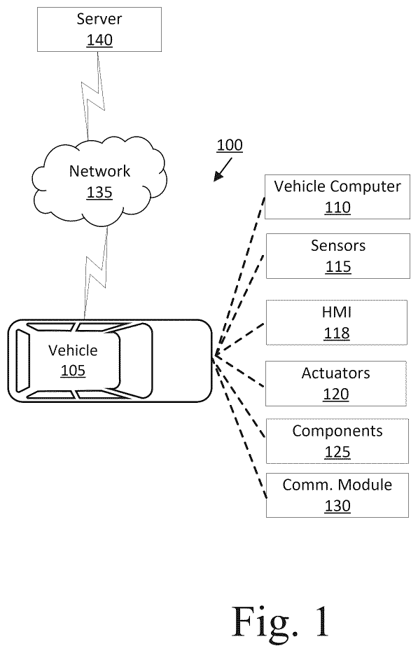

With reference to FIGS. 1-3, an example vehicle control system 100 includes a vehicle 105. A vehicle computer 110 in the vehicle 105 receives data from sensors 115. The vehicle computer 110 is programmed to detect, for respective instances, noise factors of a vehicle tire 200. The noise factors include a tire pressure, a load, and a tire speed. The vehicle computer 110 is further programmed to determine, for the respective instances, respective radii of the vehicle tire 200. The vehicle computer 110 is further programmed to group the respective radii based on respective discrete sets of noise factors. The vehicle computer 110 is further programmed to estimate a transition instance of a health condition for the vehicle tire 200 based on extrapolating the respective grouped radii.

Turning now to FIG. 1, the vehicle 105 may be any suitable type of wheeled object. For example, the vehicle may be a bicycle, a motorcycle, a unicycle, an automobile (e.g., a passenger or commercial automobile such as a sedan, a coupe, a truck, a sport utility vehicle, a crossover vehicle, a van, a minivan, a taxi, a bus, etc.), a tractor, a steamroller, etc. The vehicle 105, for example, may be an autonomous vehicle. In other words, the vehicle 105 may be autonomously operated such that the vehicle 105 may be driven without constant attention from a driver, i.e., the vehicle 105 may be self-driving without human input.

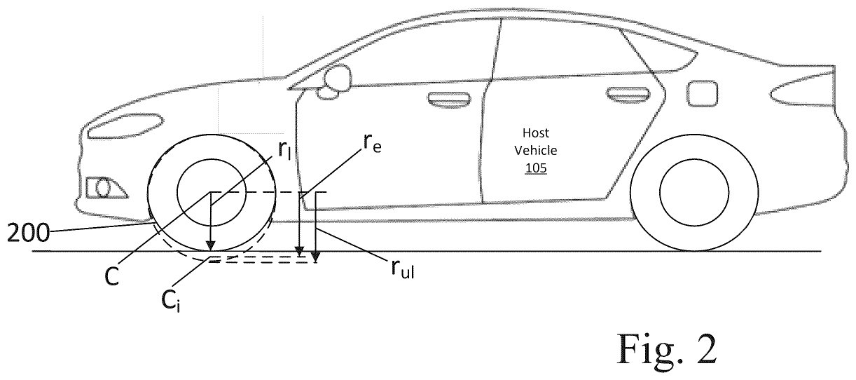

The vehicle 105 includes one or more wheels. Each wheel may, for example, include a rim and a vehicle tire 200 (see FIG. 2). The vehicle tires 200 contact a driving surface, such as a road, and the vehicle tires 200 transfer motion from a propulsion system of the vehicle 105 to the driving surface. The rim connects the vehicle tire 200 to the propulsion system and transmits motion from the propulsion system to the vehicle tire 200. The vehicle tire 200 may be rubber. The vehicle tire 200 may be pneumatic, i.e., inflated with gas such as air, nitrogen, etc. Alternatively, one or more wheels may lack a tire, such that the rim is configured to transfer motion from a propulsion system to the driving surface.

The vehicle 105 includes the vehicle computer 110, sensors 115, actuators 120 to actuate various vehicle components 125, and a vehicle communications module 130. The communications module 130 allows the vehicle computer 110 to communicate with a remote server computer 140, and/or other vehicles (e.g., via a messaging or broadcast protocol such as Dedicated Short Range Communications (DSRC), cellular, and/or other protocol that can support vehicle-to-vehicle, vehicle-to infrastructure, vehicle-to-cloud communications, or the like, and/or via a packet network 135).

The vehicle computer 110 includes a processor and a memory. The memory includes one or more forms of computer-readable media, and stores instructions executable by the vehicle computer 110 for performing various operations, including as disclosed herein. The vehicle computer 110 can further include two or more computing devices operating in concert to carry out vehicle 105 operations including as described herein. Further, the vehicle computer 110 can be a generic computer with a processor and memory as described above, and/or may include an electronic control unit (ECU) or electronic controller or the like for a specific function or set of functions, and/or may include a dedicated electronic circuit including an ASIC that is manufactured for a particular operation (e.g., an ASIC for processing sensor data and/or communicating the sensor data). In another example, the vehicle computer 110 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming (e.g. stored in a memory electrically connected to the FPGA circuit). In some examples, a combination of processor(s), ASIC(s), and/or FPGA circuits may be included in the vehicle computer 110.

The vehicle computer 110 may include programming to operate one or more of vehicle 105 propulsion, steering, transmission, climate control, interior and/or exterior lights, horn, doors, etc., as well as to determine whether and when the vehicle computer 110, as opposed to a human operator, is to control such operations.

The vehicle computer 110 may include or be communicatively coupled to (e.g., via a vehicle communications network such as a communications bus as described further below) more than one processor (e.g., included in electronic controller units (ECUs) or the like included in the vehicle 105) for monitoring and/or controlling various vehicle components 125 (e.g., a transmission controller, a steering controller, etc.). The vehicle computer 110 is generally arranged for communications on a vehicle communication network that can include a bus in the vehicle 105 such as a controller area network (CAN) or the like, and/or other wired and/or wireless mechanisms.

Via the vehicle 105 network, the vehicle computer 110 may transmit messages to various devices in the vehicle 105 and/or receive messages (e.g., CAN messages) from the various devices (e.g., sensors 115, an actuator 120, ECUs, etc.). Alternatively, or additionally, in cases where the vehicle computer 110 actually comprises a plurality of devices, the vehicle communication network may be used for communications between devices represented as the vehicle computer 110 in this disclosure. Further, as mentioned below, various controllers and/or sensors 115 may provide data to the vehicle computer 110 via the vehicle communication network.

Vehicle 105 sensors 115 may include a variety of devices such as are known to provide data to the vehicle computer 110. For example, the sensors 115 may include Light Detection And Ranging (LIDAR) sensor(s) 115, etc., disposed on a top of the vehicle 105, behind a vehicle 105 front windshield, around the vehicle 105, etc., that provide relative locations, sizes, and shapes of objects surrounding the vehicle 105. As another example, one or more radar sensors 115 fixed to vehicle 105 bumpers may provide data to provide locations of the objects, second vehicles, etc., relative to the location of the vehicle 105. The sensors 115 may further alternatively or additionally, for example, include camera sensor(s) 115 (e.g. front view, side view, etc.) providing images from an area surrounding the vehicle 105. In the context of this disclosure, an object is a physical (i.e., material) item that has mass and that can be represented by physical phenomena (e.g., light or other electromagnetic waves, or sound, etc.) detectable by sensors 115. Thus, the vehicle 105, as well as other items including as discussed below, fall within the definition of “object” herein.

The vehicle computer 110 is programmed to receive data from one or more sensors 115 substantially continuously, periodically, and/or when instructed by a remote server computer 140, etc. The data may, for example, include a location of the vehicle 105. Location data specifies a point or points on a ground surface and may be in a known form (e.g., geo-coordinates such as latitude and longitude coordinates obtained via a navigation system, as is known, that uses the Global Positioning System (GPS)). Additionally, or alternatively, the data can include a speed of the vehicle 105. The speed of the vehicle can include longitudinal and/or lateral components. Longitudinal speed data specifies a distance between points over an amount of time for the vehicle to travel from one point to the other point on the ground surface. Lateral speed data specifies a distance normal to a line extending from one point to another point over an amount of time for the vehicle to travel on the ground surface. The speed data may be obtained via the navigational system at respective (i.e., separate) instances. That is, particular speeds may be obtained at corresponding instances. The instances specify discrete moments at which the vehicle computer 110 analyzes a health condition (i.e., an amount of wear) on the vehicle tire 200. The instances may be defined by a distance (e.g., miles, kilometers, etc.) traveled by the vehicle 105 and/or an amount of time (e.g., milliseconds, seconds, minutes, etc.).

As another example, the data can include an angular speed of the wheel of the vehicle 105. Angular speed data specifies a rotational distance about an axis of rotation of the wheel over time. The angular speed data of the wheel may be obtained via a wheel speed sensor 115 at the respective instances. That is, particular angular speeds may be obtained at corresponding instances. However, due to latency in communication between the navigation system and the vehicle computer 110, the speed data may be delayed in being obtained by the vehicle computer 110. In this situation, the vehicle computer 110 can (e.g., according to known data processing techniques) introduce a time-delay to synchronize the speed data and the angular speed data (i.e., time-shift the angular speed data to compensate for the latency in communication between the navigation system and the vehicle computer 110).

As another example, the data may include pressure data of the vehicle tires 200. For example, the vehicle 105 may include a sensor for monitoring the air pressure of vehicle tires 200 (i.e., a tire pressure sensor (TPS)). The TPS returns data indicating a pressure level of the tires 200. The TPS uses pressure sensors mounted either inside or on an outer surface of each tire. Pressure sensors mounted inside the tires communicate using wireless short-range signals. The pressure data of the wheel may be obtained at the respective instances. That is, particular pressures may be obtained at corresponding instances.

As yet another example, the data may include load data. Load data specifies a weight supported by the wheels of the vehicle 105. The load data may be obtained via a weight sensor coupled to the wheel or an axle support the wheel. The weight sensor can communicate using wireless short-range signals or via the vehicle network. The load data of the wheel may be obtained at the respective instances. That is, particular loads may be obtained at corresponding instances.

The vehicle 105 actuators 120 are implemented via circuits, chips, or other electronic and or mechanical components that can actuate various vehicle subsystems in accordance with appropriate control signals as is known. The actuators 120 may be used to control components 125, including propulsion and steering of a vehicle 105.

In the context of the present disclosure, a vehicle component 125 is one or more hardware components adapted to perform a mechanical or electro-mechanical function or operation-such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a suspension component (e.g., that may include one or more of a damper, e.g., a shock or a strut, a bushing, a spring, a control arm, a ball joint, a linkage, etc.), a park assist component, an adaptive cruise control component, an adaptive steering component, etc.

The vehicle 105 further includes a human-machine interface (HMI) 118. The HMI 118 includes user input devices such as knobs, buttons, switches, pedals, levers, touchscreens, and/or microphones, etc. The input devices may include sensors 115 to detect a user input and provide user input data to the vehicle computer 110. That is, the vehicle computer 110 may be programmed to receive user input from the HMI 118. The occupant may provide the user input via the HMI 118 (e.g., by selecting a virtual button on a touchscreen display, by providing voice commands, etc.). For example, a touchscreen display included in an HMI 118 may include sensors 115 to detect that an occupant selected a virtual button on the touchscreen display to, for example, select or deselect an operation, which input can be received in the vehicle computer 110 and used to determine the selection of the user input.

The HMI 118 typically further includes output devices such as displays (including touchscreen displays), speakers, and/or lights, etc., that output signals or data to the occupant. The HMI 118 is coupled to the vehicle communication network and can send and/or receive messages to/from the vehicle computer 110 and other vehicle sub-systems.

In addition, the vehicle computer 110 may be configured for communicating via a vehicle-to-vehicle communication module 130 or interface with devices outside of the vehicle 105 (e.g., through a vehicle-to-vehicle (V2V) or vehicle-to-infrastructure (V2X) wireless communications (cellular and/or short-range radio communications, etc.) to another vehicle, and/or to a remote server computer 140 (typically via direct radio frequency communications)). The communications module 130 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 130 include cellular, Bluetooth, IEEE 802.11, dedicated short range communications (DSRC), cellular V2X (CV2X), and/or wide area networks (WAN), including the Internet, providing data communication services. The label “V2X” is used herein for communications that may be vehicle-to-vehicle (V2V) and/or vehicle-to-infrastructure (V2I), and that may be provided by communication module 130 according to any suitable short-range communications mechanism (e.g., DSRC, cellular, or the like).

The network 135 represents one or more mechanisms by which a vehicle computer 110 may communicate with remote computing devices (e.g., the remote server computer 140, another vehicle computer, etc.). Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The remote server computer 140, in some examples, can be a conventional computing device (i.e., including one or more processors and one or more memories) programmed to provide operations such as disclosed herein. Further, the remote server computer 140 can be accessed via the network 135 (e.g., the Internet, a cellular network, and/or or some other wide area network).

The vehicle computer 110 is programmed to estimate a transition instance of a health condition of the vehicle tire 200. The transition instance indicates a future distance travelled (e.g., miles, kilometers, etc.) and/or a future time (e.g., days, weeks, etc.) at which the health condition transitions from healthy to unhealthy. In the present context, a vehicle tire 200 is healthy when wear on the vehicle tire 200 is less than a wear threshold and is unhealthy when wear on the vehicle tire 200 is greater than or equal to the wear threshold. The wear threshold specifies a maximum amount of wear of the vehicle tire 200 below which the vehicle tire 200 satisfies design and performance specifications. The wear threshold may be stored (e.g., in a memory of the vehicle computer 110). The wear threshold may be determined empirically (e.g., based on testing and/or simulation to determine performance capabilities for various types of tires subjected to various amounts of wear).

The vehicle computer 110 can determine the remaining useful life of the vehicle tire 200 based on the transition instance. For example, the vehicle computer 110 can determine the remaining useful life based on a difference between a current distance travelled by the vehicle tire 200 and the estimated distance travelled indicated by the transition instance. In this situation, the vehicle computer 110 can represent the remaining useful life of the vehicle tire 200 in a distance to be traveled (e.g., miles, kilometers, etc.). Additionally, or alternatively, the vehicle computer 110 can then divide the difference by an average distance traveled (e.g., determined based on historical sensor 115 data) for a given amount of time (e.g., miles per day) to determine the remaining useful life of the vehicle tire 200. In this situation, the vehicle computer 110 can represent the remaining useful life in an amount of time.

To estimate the transition instance, it is assumed that the vehicle tire 200 is operating under a free rolling condition (i.e., not subjected to any longitudinal and/or lateral slip). A vehicle tire 200 under free rolling conditions has at least three different radius lengths (see FIG. 2): an unloaded radius rᵤₗ, a loaded radius rₗ and an effective rolling radius rₑ. An unloaded radius rᵤₗ is a radius of the vehicle tire 200 (i.e., a distance from a center C of the wheel to an outer circumferential surface of the vehicle tire 200) when the vehicle tire 200 is not in contact with the ground surface. A loaded radius rₗ is a distance between the center C of the wheel and a point at which the vehicle tire 200 contacts the ground surface. An effective rolling radius rₑ is a distance from the center C of the wheel to an instantaneous center of rotation Cᵢ (i.e., a point on the vehicle tire 200 that has no velocity at the respective instance) of the vehicle tire 200. The vehicle computer 110 estimates the transition instance based on the effective rolling radius rₑ and the unloaded radius rᵤₗ.

The vehicle computer 110 is programmed to determine the effective rolling radius rₑ of the vehicle tire 200 based on the sensor 115 data. For example, the vehicle computer 110 can obtain the speed of the vehicle 105 (e.g., for the respective instances) and the angular speed of the wheel (e.g., for the respective instances), as discussed above. The vehicle computer 110 can then determine the effective rolling radius rₑ according to:

$${r}_{e} = \frac{v}{ω} \qquad ( 1 )$$

where ν is the speed of the vehicle 105, and ω is the angular speed of the wheel. Particular effective rolling radii rₑ may be determined at corresponding instances.

The vehicle computer 110 is programmed to detect noise factors for the respective instances based on the sensor 115 data. That is, particular noise factors may be obtained at corresponding instances. The noise factors include a tire pressure, a load, and a tire speed. The vehicle computer 110 can, for example, determine the tire pressure based on the pressure data, as discussed above. The vehicle computer 110 can, for example, determine the load based on the load data, as discussed above. The vehicle computer 110, can for example, determine the tire speed based on the angular speed data, as discussed above.

Upon detecting the noise factors, the vehicle computer 110 is programmed to determine, for the respective instances, respective unloaded radii rᵤₗ based on the respective effective rolling radii rₑ and the respective detected noise factors for the respective instances. Particular unloaded radii rᵤₗ may be determined at corresponding instances. The unloaded radii rᵤₗ can be determined according to:

$${r}_{ul} = {r}_{e} + {ρ}_{0} ( D {tan}^{- 1} ( B \frac{ρ}{{ρ}_{0}} ) + E \frac{ρ}{{ρ}_{0}} ) \qquad ( 2 )$$

where ρ₀ is an expected deflection of a vehicle tire 200 subjected to a nominal load, ρ is an actual deflection of the vehicle tire 200 (e.g., determined according to known calculation methods given a tire pressure, a load, and a type of the vehicle tire 200) for the respective instance, D is a parameter that is based on the load and varies as the load varies, B is a parameter based on a downward force on the vehicle tire 200 along a tire characteristic curve (i.e., a graphical representation of a relationship between different tire characteristics, such as slip angle, lateral force, friction coefficient, slip velocity, etc.), and E is a parameter based on tire stiffness and varies with the tire pressure. B, D, and E may be derived, for example, from a look-up table, or the like, that associates respective values of B, D, and E with the respective discrete sets of noise factors. The look-up table may be stored (e.g., in a memory of the vehicle computer 110). The look-up table may be determined empirically (e.g., based on testing and/or simulation to determine various values of the respective parameters B, D, and E for various values of the respective noise factors).

The vehicle computer 110 can then group the respective unloaded radii rut based on respective discrete sets of noise factors. That is, the respective unloaded radii rut that are determined (e.g., according to Equation 2) based on respective detected noise factors that fall within a common discrete set of noise factors are grouped together. The respective discrete sets of noise factors are defined by respective minimum thresholds and respective maximum thresholds of the respective noise factors. The respective minimum thresholds and the respective maximum thresholds define respective neighborhoods (or bins) for the respective set of noise factors that are contiguous across respective ranges (i.e., respective differences between respective maximums and respective minimums) of the respective noise factors. The respective minimum thresholds and the respective maximum thresholds can be determined empirically (e.g., based on testing and/or simulation to determine a number of neighborhoods that can be analyzed given available computational resources of the vehicle computer 110).

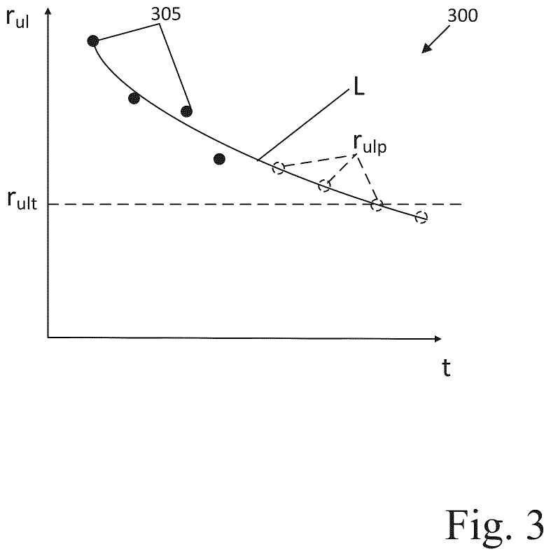

FIG. 3 is a hypothetical representation of data illustrating an exemplary plot 300 of respective grouped unloaded radii rᵤₗ over time t (i.e., from one instance to another instance) for one respective discrete set of noise factors. The vehicle computer 110 can generate respective plots 300 for each of the respective discrete sets of noise factors that graphically represents a change in the respective grouped unloaded radii rut over time t. The vehicle computer 110 can then, for the respective discrete sets of noise factors, predict future unloaded radii rᵤₗₚ (shown in broken lines in FIG. 3). To predict the future unloaded radii rᵤₗₚ for the respective discrete sets of noise factors, the vehicle computer 110 can determine a best fit line L for the respective grouped unloaded radii rᵤₗ (e.g., according to known calculation methods (e.g., linear least squares, linear regression, random sample consensus (RANSAC), etc.)). The best fit line L is a line through points 305 (representing the respective unloaded radii rᵤₗ at the respective instances) that minimizes respective distances between the respective points 305 and the line L. The vehicle computer 110 can then extrapolate the best fit line L (e.g., using known extrapolation methods such as linear extrapolation) to predict the future unloaded radii rᵤₗₚ for the respective discrete set of noise factors at future instances in time.

The vehicle computer 110 can determine respective discrete transition instances (i.e., respective transition instances for the respective discrete sets of noise factors) based on the respective predicted future unloaded radii rᵤₗₚ. For example, for the respective discrete set of noise factors, the vehicle computer 110 can compare the respective predicted future unloaded radii rᵤₗₚ to an unloaded radius threshold rᵤₗₜ. The unloaded radius threshold rᵤₗₜ specifies a radius at which wear on the vehicle tire 200 reaches the wear threshold. The unloaded radius threshold rᵤₗₜ may be determined empirically (e.g., based on testing and/or simulation to determine various radii at which various type of vehicle tires 200 reach corresponding wear thresholds) or can be set based on vehicle performance requirements. The unloaded radius threshold rᵤₗₜ may be stored (e.g., in a memory of the vehicle computer 110). Upon identifying, for each of the respective discrete sets of noise factors, the respective predicted future unloaded radius rᵤₗₚ that first reaches or exceeds the unloaded radius threshold rᵤₗₜ, the vehicle computer 110 determines the respective discrete transition instance to be a same future instance associated with the respective predicted future unloaded radius rᵤₗₚ that first reaches or exceeds the unloaded radius threshold rᵤₗₜ.

The vehicle computer 110 can estimate the transition instance based on the respective discrete transition instances. For example, the vehicle computer 110 can utilize a probabilistic model to estimate the transition instance. In this situation, the vehicle computer 110 can determine an earliest discrete transition instance (i.e., a transition instance predicted to occur at a future instance that is closest (e.g., in distance and/or time) to a current instance) from the respective discrete transition instances (e.g., based on a minimum function) and a latest discrete transition instance (i.e., a transition instance predicted to occur at a future instance that is farthest (e.g., in distance and/or time) from a current instance) from the respective discrete transition instances (e.g., based on a maximum function). The vehicle computer 110 can then estimate that the transition instance will be between the earliest discrete transition instance and the latest discrete transition instance.

As another example, the vehicle computer 110 can utilize a deterministic model to estimate the transition instance. In this situation, the vehicle computer 110 can count a number of points 305 (i.e., unloaded radii rᵤₗ) in the respective plots 300 for each of the respective discrete sets of noise factors and select the plot 300 with the greatest number of points 305. The vehicle computer 110 can then estimate the transition instance to be the discrete transition instance of the selected plot 300.

The vehicle computer 110 can be programmed to output the remaining useful life of the vehicle tire 200 to a user. The vehicle computer 110 can determine the remaining useful life of the vehicle tire 200 based on the estimated transition instance, as discussed above. For example, the vehicle computer 110 can actuate the HMI 118 to output a message specifying the remaining useful life of the vehicle tire 200. In the situation in which the probabilistic model is utilized, the message may specify a range (e.g., defined by respective remaining useful lives determined based on the earliest discrete transition instance and the latest discrete transition instance, respectively) for the remaining useful life of the vehicle tire 200. In the situation in which the deterministic model is utilized, the message may specify a remaining useful life determined based on the discrete transition instance of the selected plot 300. The message may, for example, be a visual message (e.g., text represented on a display on a dash, an infotainment system and/or a user device (e.g., a mobile phone of the user)). As another example, the message may be an audible message (e.g., output via speakers in the vehicle 105 or the user device).

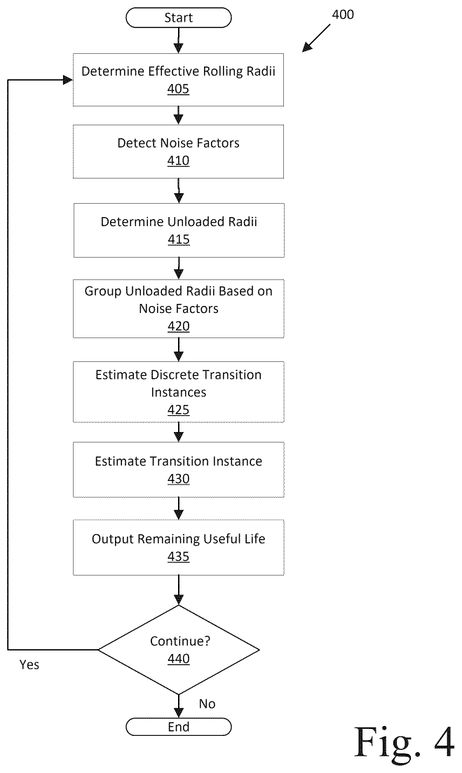

FIG. 4 is a diagram of an example process 400 for determining a remaining useful life of a vehicle tire 200. The process 400 begins in a block 405. The process 400 can be carried out by a vehicle computer 110 included in a vehicle 105 executing program instructions stored in a memory thereof.

In the block 405, the vehicle computer 110 determines, for respective instances, respective effective rolling radii rₑ of the vehicle tire 200. For example, the vehicle computer 110 can obtain (e.g., via a navigation system) speed data for the respective instances and (e.g., via sensors 115) angular speed data of the vehicle tire 200 for the respective instances, as discussed above. The vehicle computer 110 can then calculate the respective effective rolling radii rₑ via Equation 1 above. The process 400 continues in a block 410.

In the block 410, the vehicle computer 110 detects noise factors for the respective instances. The noise factors include a tire pressure, a load, and a tire speed. The vehicle computer 110 can determine the respective noise factors based on sensor 115 data, as discussed above. The process 400 continues in a block 415.

In the block 415, the vehicle computer 110 determines, for the respective instances, respective unloaded radii rᵤₗ of the vehicle tire 200. The respective unloaded radii rᵤₗ of the vehicle tire 200 can be determined according to Equation 2 above. The process 400 continues in a block 420.

In the block 420, the vehicle computer 110 groups the respective unloaded radii rᵤₗ based on respective discrete sets of noise factors, as discussed above. The vehicle computer 110 can then generate, for the respective discrete sets of noise factors, respective plots 300 representing a change in the respective grouped unloaded radii rᵤₗ over time t, as discussed above. The process 400 continues in a block 425.

In the block 425, the vehicle computer 110 estimates respective discrete transition instances based on the respective plots 300. For example, the vehicle computer 110 can extrapolate the grouped unloaded radii rᵤₗ via a best fit line L to predict future unloaded radii rᵤₗₚ at future instances, as discussed above. The vehicle computer 110 can then compare the predicted future unloaded radii rᵤₗₚ to an unloaded radius threshold rᵤₗₜ, as discussed above. The vehicle computer 110 determines the respective discrete transition instance to be a same future instance associated with the respective predicted future unloaded radius rᵤₗₚ that first reaches or exceeds the unloaded radius threshold rᵤₗₜ, as discussed above. The process 400 continues in a block 430.

In the block 430, the vehicle computer 110 estimates a transition instance based on the respective discrete transition instances. For example, the vehicle computer 110 can utilize a probabilistic model to estimate the transition instance, as discussed above. As another example, the vehicle computer 110 can utilize a deterministic model to estimate the transition instance, as discussed above. The process 400 continues in a block 435.

In the block 435, the vehicle computer 110 outputs a remaining useful life of the vehicle tire 200. The vehicle computer 110 can, for example, acuate an HMI 118 to output an audio and/or visual message to a user specifying the remaining useful life of the vehicle tire 200, as discussed above. The vehicle computer 110 can determine the remaining useful life of the vehicle tire 200 based on the transition instance, as discussed above. The process 400 continues in a block 440.

In the block 440, the vehicle computer 110 determines whether to continue the process 400. For example, the vehicle computer 110 can determine not to continue when the vehicle 105 is in an OFF state. Conversely, the vehicle computer 110 can determine to continue while the vehicle 105 is in an ON state. If the vehicle computer 110 determines to continue, the process 400 returns to the block 405. Otherwise, the process 400 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board first computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A system, comprising a computer including a processor and a memory, the memory storing instructions executable by the processor to:
detect, for respective instances, noise factors of a vehicle tire, the noise factors including a tire pressure, a load, and a tire speed;
determine, for the respective instances, respective radii of the vehicle tire;
group the respective radii based on respective discrete sets of noise factors; and
estimate a transition instance of a health condition for the vehicle tire based on extrapolating the respective grouped radii.

2. The system of claim 1, wherein the instructions further include instructions to determine the respective radii based on respective vehicle speeds and respective angular speeds of the vehicle tire.

3. The system of claim 2, wherein the instructions further include instructions to determine the respective radii based further on the detected noise factors.

4. The system of claim 1, wherein the instructions further include instructions to, in response to determining a remaining useful life of the vehicle tire based on the estimated transition instance, actuate a human-machine interface to output a message specifying the remaining useful life.

5. The system of claim 1, wherein the respective discrete sets of noise factors are defined by respective minimum thresholds and respective maximum thresholds for the respective noise factors.

6. The system of claim 1, wherein the transition instance is estimated via a probabilistic model.

7. The system of claim 1, wherein the transition instance is estimated via a deterministic model.

8. The system of claim 1, wherein the transition instance indicates a future distance travelled or a future time at which the health condition transitions from healthy to unhealthy.

9. The system of claim 8, wherein the vehicle tire is healthy based on wear of the vehicle tire being less than a wear threshold, and the vehicle tire is unhealthy based on the wear being greater than or equal to the wear threshold.

10. The system of claim 1, wherein the noise factors are detected via vehicle sensor data.

11. A method, comprising:
detecting, for respective instances, noise factors of a vehicle tire, the noise factors including a tire pressure, a load, and a tire speed;
determining, for the respective instances, respective radii of the vehicle tire;
grouping the respective radii based on respective discrete sets of noise factors; and
estimating a transition instance of a health condition for the vehicle tire based on extrapolating the respective grouped radii.

12. The method of claim 11, further comprising determining the respective radii based on respective vehicle speeds and respective angular speeds of the vehicle tire.

13. The method of claim 12, further comprising determining the respective radii based further on the detected noise factors.

14. The method of claim 11, further comprising, in response to determining a remaining useful life of the vehicle tire based on the estimated transition instance, actuating a human-machine interface to output a message specifying the remaining useful life.

15. The method of claim 11, wherein the respective discrete sets of noise factors are defined by respective minimum thresholds and respective maximum thresholds for the respective noise factors.

16. The method of claim 11, wherein the transition instance is estimated via a probabilistic model.

17. The method of claim 11, wherein the transition instance is estimated via a deterministic model.

18. The method of claim 11, wherein transition instance indicates a future distance travelled or a future time at which the health condition transitions from healthy to unhealthy.

19. The method of claim 18, wherein the vehicle tire is healthy based on wear of the vehicle tire being less than a wear threshold, and the vehicle tire is unhealthy based on the wear being greater than or equal to the wear threshold.

20. The method of claim 11, wherein the noise factors are detected via vehicle sensor data.
